(19) United States
(12) Patent Application Publication
(10) Pub. No.: US 2017/0332055 A1
(43) Pub. Date: Nov. 16, 2017

(54) DOOR LOCK AND DOOR SECURITY SYSTEM

(71) Applicant: STRATTEC ADVANCED LOGIC, Milwaukee, WI (US)

(72) Inventor: Kevin Henderson, Davenport, FL (US)

(73) Assignee: STRATTEC ADVANCED LOGIC, Milwaukee, WI (US)

(21) Appl. No.: 15/531,173

(22) PCT Filed: Dec. 29, 2014
(86) PCT No.: PCT/US14/72561

§ 371 Date: May 26, 2017

Related U.S. Application Data
(60) Provisional application No. 62/085,005, filed on Nov. 26, 2014.

(51) Int. Cl. H04N 7/18; G07C 9/00; G08B 13/196; G08B 13/00; E05C 1/00; H04N 7/00

(52) U.S. Cl. CPC H04N 7/186; G08B 13/1966; G07C 9/00174; G07C 9/00; E05C 1/00; H04N 7/00; G08B 13/00

(57) ABSTRACT

Door locks, door locking and unlocking methods, and door security and communications devices are provided, and can include an exterior module mountable on an exterior surface of a door; an interior module mountable on an interior surface of a door; a deadbolt movable between an unlocked position allowing opening of the door from a closed state and a locked position preventing opening of the door from the closed state; a camera and/or a microphone provided on the exterior module; and a wireless communication device configured to communicate images from the camera and/or sound from the microphone to a smart phone or computer of an authorized user for remote observation of an area adjacent the exterior surface of the door.

### CROSS-REFERENCE TO RELATED APPLICATIONS

This application claims priority to U.S. Provisional Patent Application Ser. No. 62/085,005, filed Nov. 26, 2014, the entire contents of which are incorporated by reference herein.

### BACKGROUND

The present invention relates to doors with secured access, for example, in a building such as a home, apartment, condominium, hotel room, or business. For enhanced security, many users utilize deadbolt devices, peep holes, and/or surveillance cameras.

### BRIEF DESCRIPTION OF THE DRAWINGS

FIG. 1 is a perspective view of a dwelling having a door secured by a door lock according to one embodiment of the present invention.

FIG. 2 is a perspective view of an interior side of the dwelling and the door of FIG. 1.

FIG. 3 is a front view of an exterior module of the door lock as shown in FIG. 1. A default home menu is displayed.

FIG. 4 is a front view of the exterior module of the door lock as shown in FIG. 1. A communication sub-menu is displayed.

FIG. 5 is a front view of the exterior module of the door lock as shown in FIG. 1. A call sub-screen is displayed.

FIG. 6 is a front view of the exterior module of the door lock as shown in FIG. 1. A message sub-screen is displayed.

FIG. 7 is a front view of the exterior module of the door lock as shown in FIG. 1. A user identification sub-screen is displayed.

FIG. 8 is a front view of the exterior module of the door lock as shown in FIG. 1. A PIN entry sub-screen is displayed.

FIG. 9 is a front view of an interior module of the door lock as shown in FIG. 2. A default home status screen is displayed.

FIG. 10 is a front view of the interior module of the door lock as shown in FIG. 2. A main menu is displayed.

FIG. 11 is a front view of the interior module of the door lock as shown in FIG. 2. A main settings menu is displayed.

FIG. 12 is a front view of the interior module of the door lock as shown in FIG. 2. A users management menu is displayed.

FIG. 13 is a front view of the interior module of the door lock as shown in FIG. 2. A user detail screen is displayed for adding a new user.

FIG. 14 illustrates a computer software interface for communicating with the door lock.

FIG. 15 illustrates the computer software interface listing a plurality of authorized users.

FIG. 16 illustrates a mobile device application for communicating with the door lock.

FIG. 17 is a schematic view illustrating the door lock in communication with a plurality of devices via location-specific and wide-area networks.

FIG. 18 illustrates an exemplary menu navigation map for the interior module of the door lock as shown in FIG. 2

FIG. 19 illustrates an exemplary menu navigation map for the exterior module of the door lock as shown in FIG. 1.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

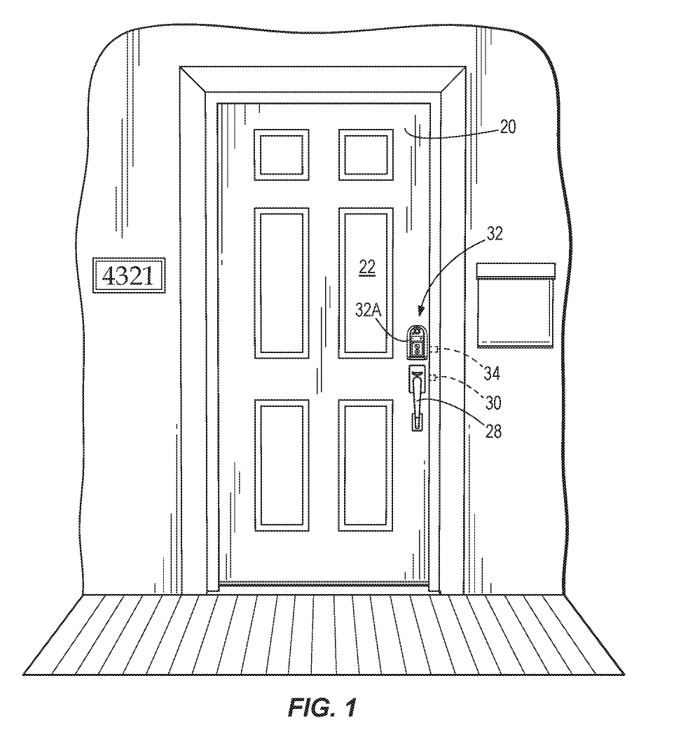

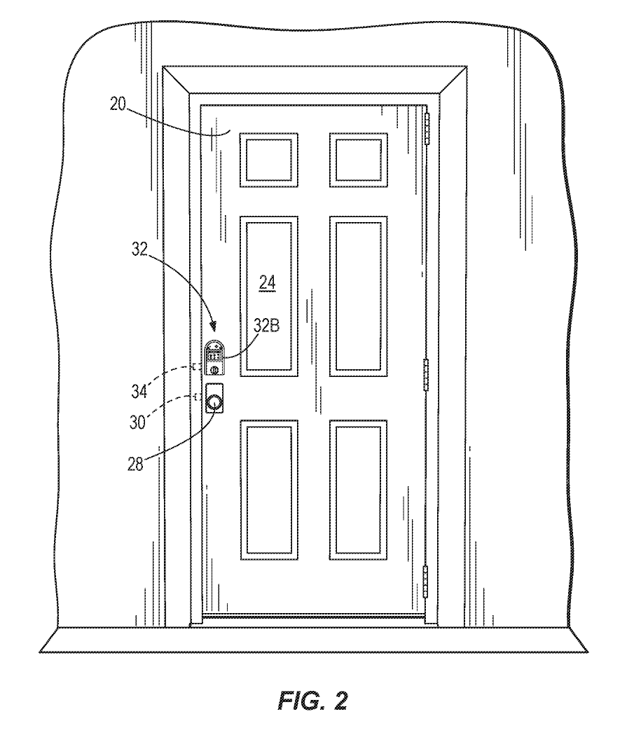

In a home, apartment, condominium, hotel room, place of business, or other dwelling or secured space, door security is often important (i.e., the ability to lock the door to secure a space, and to only selectively unlock upon proper verification to provide access to the space). FIGS. 1 and 2 illustrate an exemplary dwelling having a door 20 with an exterior surface 22 and an interior surface 24. The door 20 can be a conventional hinged residential door, but it will be understood that other types of doors are used in other constructions (e.g., sliding doors, roll-up garage type doors, and the like). As illustrated, the door 20 includes a handle 28 that is manually operable by a user's hand to retract a latch 30 of the door 20 to allow opening of the door 20 from a closed position to an open position. Although the latch 30 may be a lockable latch in some constructions such that the latch 30 defines a locking element to prevent opening of the door 20, the illustrated door 20 is further provided with a separate door lock 32 in the form of a deadbolt device. The illustrated door lock 32 includes a locking element in the form of a deadbolt 34 operable between an extended or locked position which prevents opening of the door 20 and a retracted or unlocked position which allows opening of the door. The door lock 32 includes an exterior portion or module 32A and an interior portion or module 32B. The exterior module 32A may be used by an authorized user or occupant of the secured space, and may be used in other scenarios by a visitor who may be authorized or unauthorized to enter the secured space. As used herein, “authorized” refers to person(s) who have established privilege to enter the secured space by unlocking the door lock 32. An “administrator-level” user refers to a person having authority to set up approvals of authorized users, among other parameters and features. For example, an administrator-level user may be a home resident or business owner/manager, and authorized users can include known relatives, friends, employees, etc. who may be granted privilege to unlock the door lock 32 by the administrator-level user. Although an unauthorized user may not unlock the door lock 32, the unauthorized user may operate or otherwise interface with the door lock 32 to utilize certain other features of the door lock 32 as described further herein.

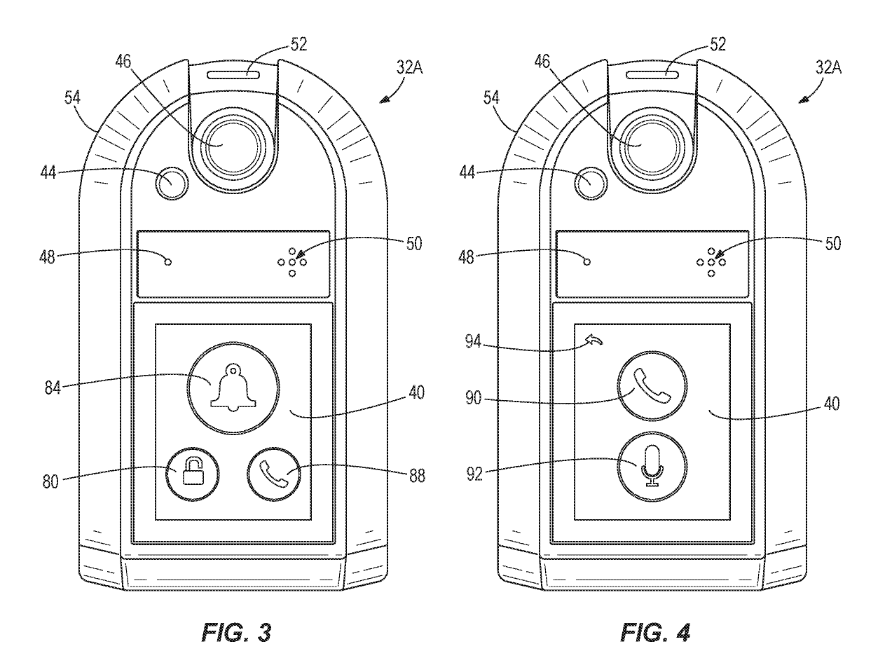

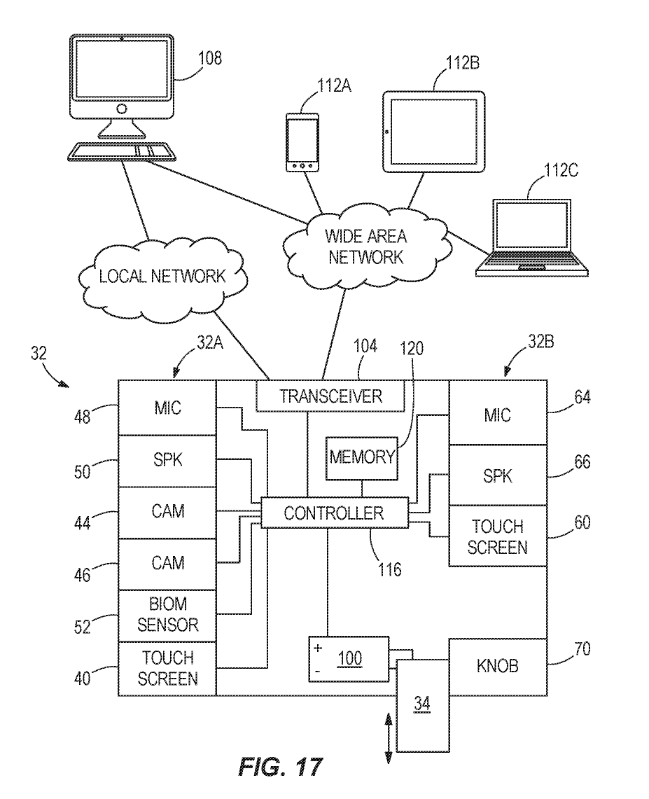

The exterior module 32A, which is shown in more detail in FIGS. 3-8, with components thereof also shown schematically in FIG. 17, includes an interface having an array of sensors and/or inputs for communicating with or collecting information from a user present at the area adjacent the exterior side 22 of the door 20. For example, the interface of the exterior module 32A can include a touch screen 40. The touch screen 40 can be responsive to human touch to control a series of commands, which may navigate through a plurality of menus or windows displayed on the touch screen 40. Alternately or in addition, one or both of a non-touch screen display and a physical keypad (e.g., numeric or alpha-numeric) can be provided on the exterior module 32A. A physical keypad can include one or more keys or buttons having a dedicated function and/or a standard array of keys or buttons that function to provide inputs to menu-driven requests. The interface can also include one or more cameras operable to detect motion, take still images, and/or take video. Various operations utilizing the cameras are described in further detail below. In the illustrated construction, the exterior module 32A includes a first camera 44 that is an infrared (IR) camera operable as a motion detector, and the exterior module 32A further includes a second camera 46 that is a digital (e.g., CMOS) camera operable to collect still images and video. The interface of the exterior module 32A can further include a microphone 48 and a speaker 50. The interface of the exterior module 32A can further include a biometric device or sensor 52 operable to detect a biometric parameter of a user and to identify an authorized user by the biometric parameter. For example, the biometric device 52 can be a fingerprint scanner, although other constructions may utilize a biometric sensor operable to identify a user by alternate biometric parameters (e.g., voice, retinal scan, etc.). Any or all of the various portions making up the interface of the exterior module 32A can be provided in a common case or housing 54.

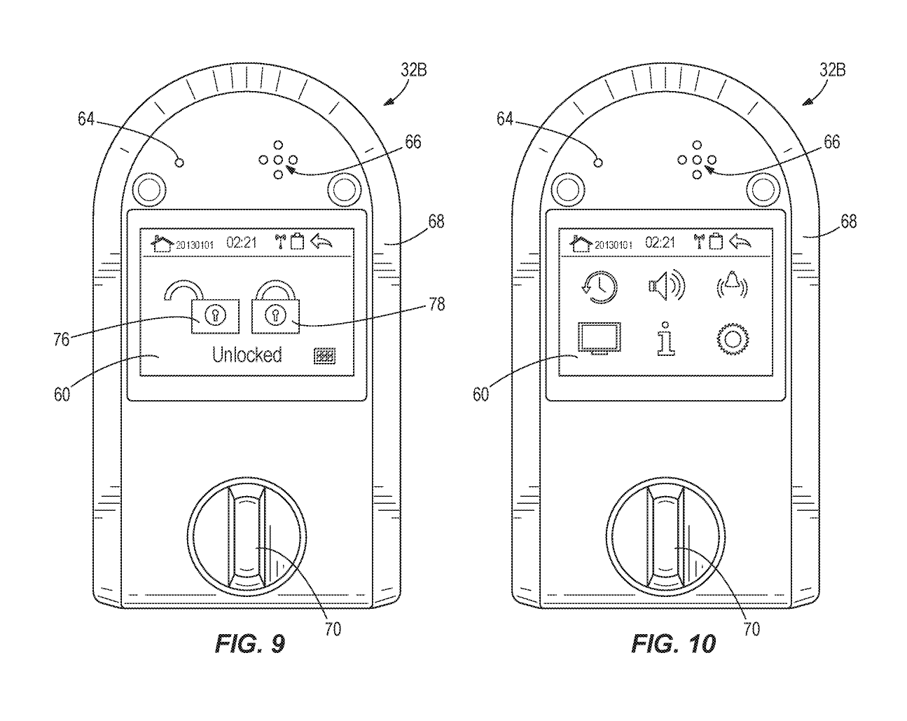

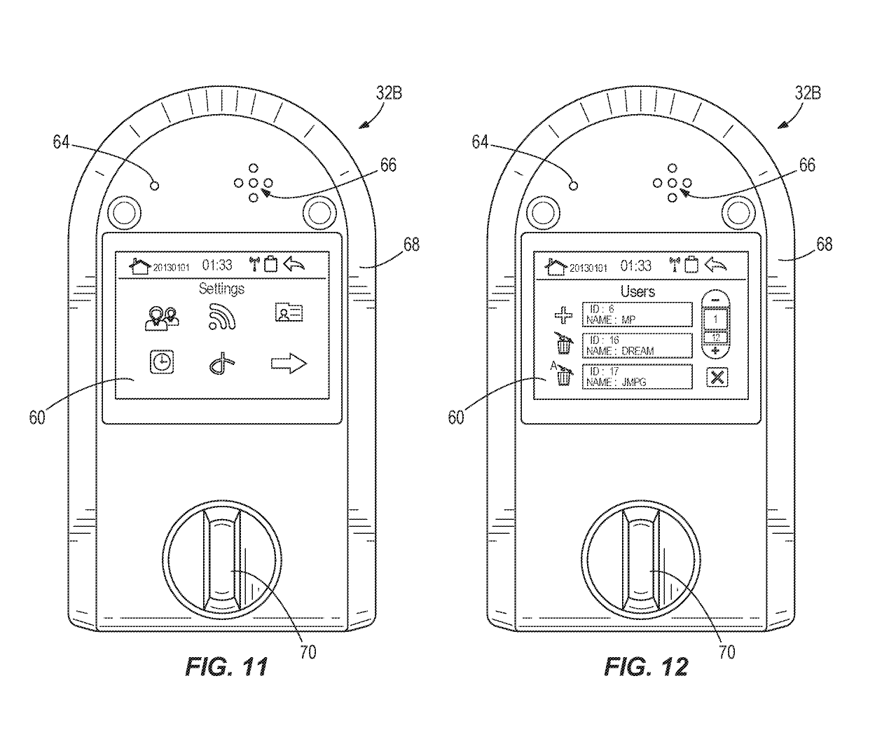

The interior module 32B, which is shown in more detail in FIGS. 9-12, with components thereof also shown schematically in FIG. 17, includes an interface having an array of sensors and/or inputs for communicating with or collecting information from a user present at the area adjacent the interior side 24 of the door 20. For example, the interface of the interior module 32B can include a touch screen 60. The touch screen 60 can be responsive to human touch to control a series of commands, which may navigate through a plurality of menus or windows displayed on the touch screen 60. Alternately or in addition, one or both of a non-touch screen display and a physical keypad (e.g., numeric or alpha-numeric) can be provided on the interior module 32B. A physical keypad can include one or more keys or buttons having a dedicated function and/or a standard array of keys or buttons that function to provide inputs to menu-driven requests. The interface of the interior module 32B can further include a microphone 64 and a speaker 66. Any or all of the various portions making up the interface of the interior module 32B can be provided in a common case or housing 68. As shown in FIGS. 11 and 12, the interior module 32B of the illustrated embodiment further includes a manually operable knob 70 coupled to the deadbolt 34 to move the deadbolt 34 between the locked and unlocked positions. The knob 70 can have one of any number of physical forms which facilitate grasping and rotation, sliding, or other movement by a human hand. The knob 70 may serve as a back-up or failsafe to an electrically-powered actuator 100 (e.g., electric motor) which is coupled to the deadbolt 34 to move the deadbolt 34 between the locked and unlocked positions in response to an electrical control signal from a controller 116 of the door lock 32. Such a control signal may be generated by the controller 116 in response to an input from either of the interfaces of the respective exterior and interior modules 32A, 32B.

In operation, the door lock 32 can be operated to lock and unlock electronically from either the interior or exterior of the door 20. From the interior, any person, whether pre-authorized or not, can operate the door lock 32 by utilizing either the touch screen 60 or the manually operable knob 70. When using the touch screen 60, the user may simply touch an icon correlating to a LOCK function or an UNLOCK function. For example, FIG. 9 illustrates a default home status screen of the touch screen 60 having a first UNLOCK icon 76 of an unlocked padlock and a second LOCK icon 78 of a locked padlock, respectively programmed to carry out the associated function on the deadbolt 34 (e.g., through controlled operation of the electric motor 100 positioned within the door lock 32). The home status screen may further indicate via text the current status of the door lock 32 as shown. In some constructions or modes of operation, the interior module 32B may be configured to only allow operation of the deadbolt 34 after confirming authorization of the user, such as by entry of a PIN (personal identification number) via the touch screen 60.

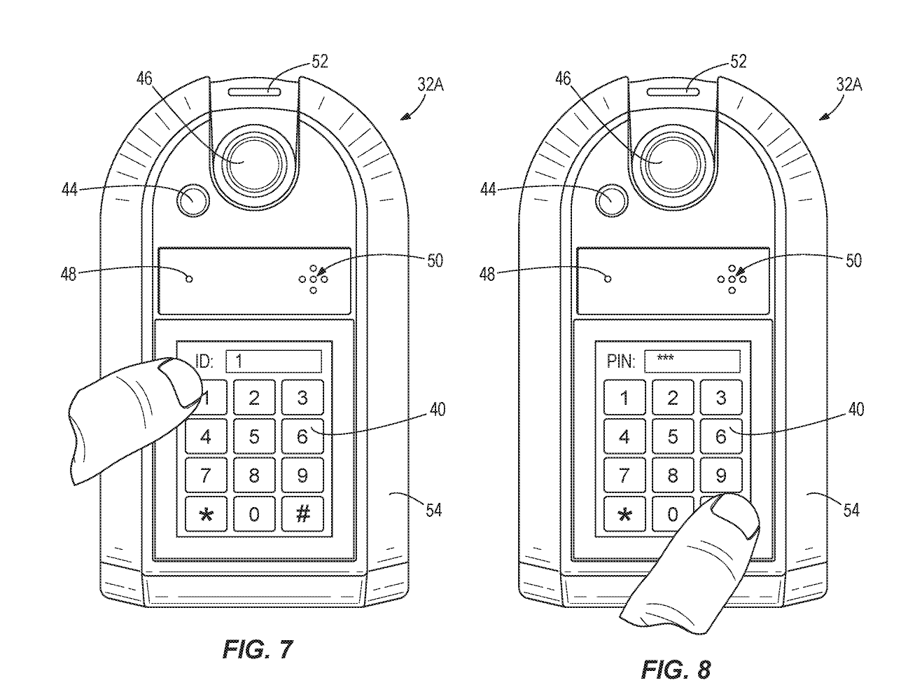

In order to lock or unlock the door lock 32 from the exterior of the door 20, a user may touch the LOCK/UNLOCK icon 80 on the default home screen menu of the touch screen 40 shown in FIG. 3. This will prompt the interface of the exterior module 32A to request verification of the user's credentials. For example, the touch screen 40 may display a dialog box and keypad as shown in FIG. 7. In the illustrated embodiment, the dialog box requests the user to input a user ID code (e.g., a name or number that identifies the user). Upon entry of the user ID, the user can advance to the next screen by pressing a key (e.g., the “#” key, or a key designated “enter”, “go” or the like). This brings up the PIN entry screen as shown in FIG. 8, where the user is requested to enter the pre-programmed PIN associated with the user ID entered on the previous screen. When finished entering the PIN, the user may press a designated key. If the controller 116 determines that the PIN entered does in fact match that associated with the user ID and that the user ID corresponds to an authorized user (e.g., from a list of authorized users accessible to the controller 116, such as a list of authorized user IDs and corresponding PINs stored in a memory 120 electronically accessible by the controller 116), the controller 116 will actuate the motor 100 to operate the deadbolt 34 (e.g., unlocking the deadbolt 34 from the locked position).

The interface of the exterior module 32A may also allow the user to verify his/her credentials without entering the PIN. For example, after entering the user ID, the user may elect to verify by biometrics using the biometric sensor 52. A designated key (e.g., “*”) may be pressed to switch the identification mode from PIN to biometric. In one example, the biometric sensor 52 is a fingerprint scanner, and the user may swipe a finger across the sensor 52 or place one or more fingers on a sensor pad for detection. Thus, a user may have multiple manners of verifying their identity to the door lock 32 (e.g., in the event that the user forgets his or her PIN). The door lock 32 can be programmed to authorize a single user, or to authorize any plurality of users within the limit of the capacity of the memory 120 associated with the controller 116. In some configurations or for some users, the door lock 32 may not be programmed to actuate the motor 100 to operate the deadbolt 34 once the controller 116 verifies the user's credentials. For example, the verification may only enable additional functions of the door lock 32 (e.g., permitting a call function or a message function as described in further detail below).

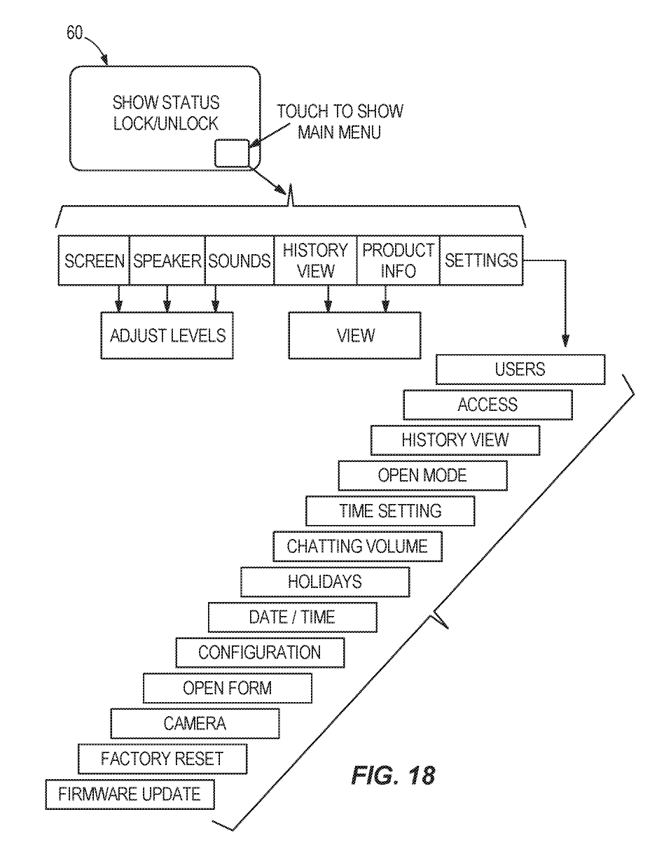

If the user present at the outside of the door 20 is not an authorized user, or elects not to enter his or her credentials, the user may elect to utilize a doorbell function, a call function, or a message function of the door lock 32. To utilize the doorbell function of the door lock 32, the user touches the DOORBELL icon 84 displayed on the home menu of the touch screen 40 (FIG. 3). In response, the controller 116 (FIG. 17) actuates the sounding of a doorbell within the dwelling. The doorbell may sound directly from the speaker 66 provided on the interior module 32B. Alternately or in addition, the door lock 32 may communicate with a remote speaker within the dwelling and/or provide a doorbell sound or other notification to an administrator-level user remote from the dwelling. For example, the door lock 32 can include a wireless communication device 104, or “transceiver” (FIG. 17), configured to communicate wirelessly (e.g., via Z-Wave, wireless router, Bluetooth device, etc.) with a personal computer 108 within the dwelling, a standalone speaker, or an authorized communication-enabled electronic device such as a mobile phone 112A, tablet computer 112B, or other personal computer 112C. The method of communication can be selected through an “Access” screen through a “Settings” selection from the a “Main Menu” as shown in FIG. 18. The sound played as the doorbell and/or any alternative style of notification (e.g., e-mail, SMS or MMS text message, or other software application pop-up alert) may be selected by the administrator-level user, and may vary depending on settings preselected by the administrator-level user. FIG. 17 schematically illustrates some of the available communication links between the door lock 32 and a variety of devices via the wireless communication device 104 and at least one network. It should be understood that FIG. 17 provides numerous specific examples of hardware and connections, some or all of which may be present in a given implementation of the invention, or which may be in operation at different times during use.

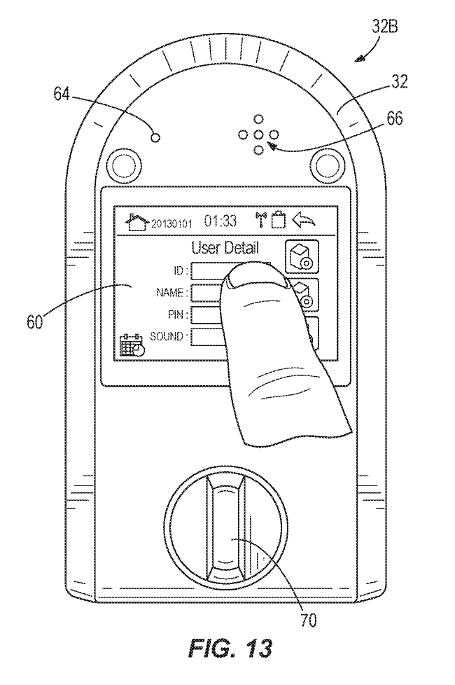

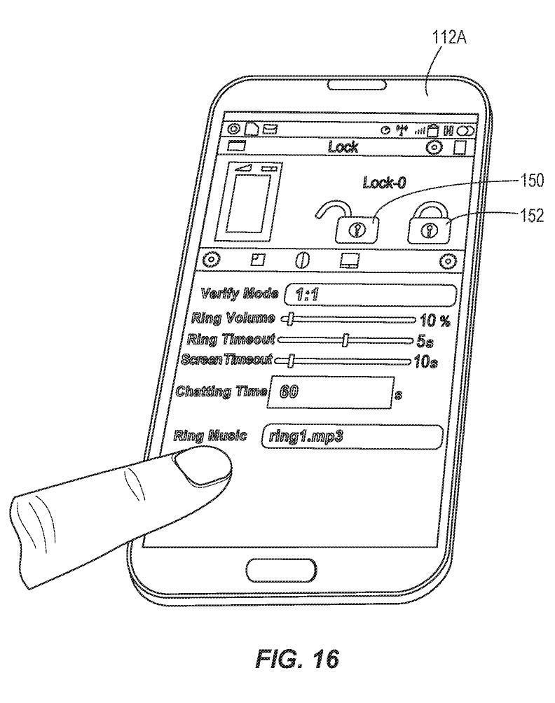

It should also be noted that the doorbell function may be triggered automatically upon an authorized user unlocking the door lock 32 to enter the dwelling, or upon entry of an authorized or unauthorized user of a PIN or biometric scan (as discussed herein). In this sense, the doorbell function serves as an announcement or welcome. The sound played by the doorbell in this function can be personalized to individual users. For example, a computer software or web portal interface that communicates with the door lock 32 can be used to set up a user profile for each user, selecting whether or not a doorbell is triggered, and if so, what sound to play. The sound can be selected from a number of pre-loaded options, or may be recorded as a custom sound or message. The user profiles, including personalized doorbells, can be set up through the administrator-level user's personal computer 108, or through a dedicated mobile application (FIG. 16) associated with the door lock 32 and installed on the user's mobile phone 112A, tablet 112B, or remote personal computer 112C (see FIG. 17), collectively referred to herein as the “remote device”. User profiles can also be managed directly through the interior module 32B (FIG. 12). As shown in FIG. 18, the user navigates to the “Users” submenu from the home screen of the touch screen 60 of the interior module 32B by selecting “Main Menu”, then “Settings”, then “Users”. In the “Users” submenu, the user can manage or edit the existing list of users and/or add new users by selecting a corresponding icon, leading to a “User Detail” screen as shown in FIG. 13. To set up a new user, the illustrated system requests a variety of parameters associated with that particular user. As shown in FIG. 13, these can include “ID”, “Name”, “PIN”, and “Sound”. From the User Detail screen, the user can also enable biometric authentication, which prompts the system to request entry of the biometric information (e.g., fingerprint scan).

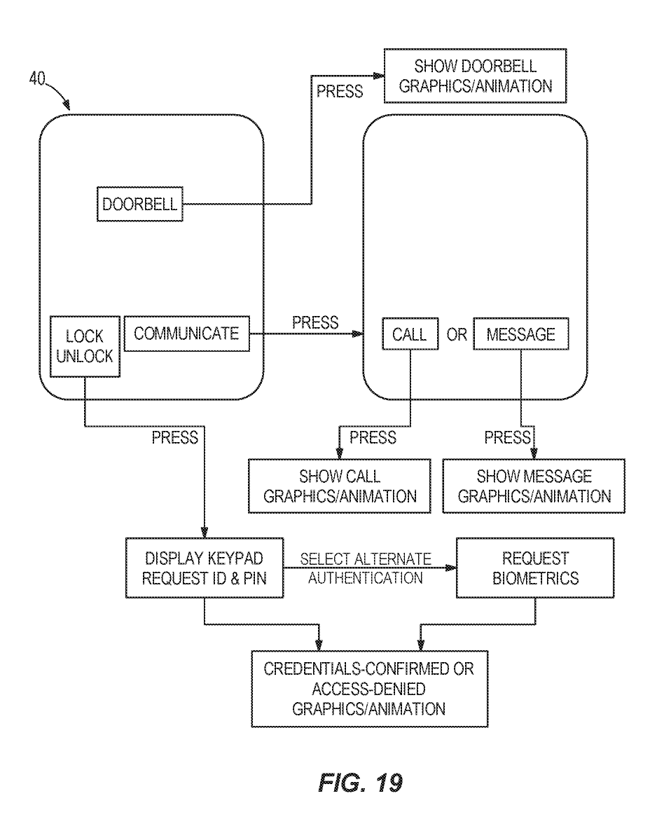

In some constructions, the use of the doorbell function can trigger an alert to be sent to an administrator-level user's mobile device (e.g., through initial secure wireless communication between the door lock 32 and a wireless local area network). For example, and with reference to the home screen shown in FIG. 3 of the illustrated embodiment, a user can press the DOORBELL icon 84 to trigger the controller 116 of the door lock 32 to transmit a wireless signal from the wireless communication device 104 to an administrator-level user's remote device indicating that the DOORBELL icon 84 has been pressed. This serves to provide notification that someone has visited the door 20. The controller 116 may also trigger the camera 46 upon usage of the doorbell function so that a picture or video clip can accompany the notification to the administrator-level user, and/or can trigger the microphone 48 to capture an audio clip upon usage of the doorbell function so that an audio clip can accompany the notification. The operation of the exterior touch screen 40 is illustrated in FIG. 19.

The notification and any accompanying picture, video clip, and/or audio clip can be sent by any suitable means, such as SMMS, e-mail, or through a dedicated mobile application (FIG. 16) associated with the door lock 32. For example, the notification and any accompanying picture, video clip, and/or audio clip can be transmitted by a network associated with the home, apartment, condominium, hotel room, or business of which the door 20 and the door lock 32 is a part (such as a local area network (“LAN”), a neighborhood area network (“NAN”), a home area network (“HAN”), or personal area network (“PAN”) employing any of a variety of communications protocols, such as Wi-Fi, Bluetooth, ZigBee, Z-Wave, etc.) to the personal computer 108 at the home, apartment, condominium, hotel room, or business. The local wireless communication protocol for the door lock 32 can be selected via an “Access” screen under the “Settings” menu as shown in FIG. 18. The personal computer 108 at the dwelling can then transmit (e.g., automatically) this data to the administrator-level user's remote device via a wide-area network (“WAN”) (e.g., a TCP/IP based network, a cellular network, such as, for example, a Global System for Mobile Communications [“GSM”] network, a General Packet Radio Service [“GPRS”] network, a Code Division Multiple Access [“CDMA”] network, an Evolution-Data Optimized [“EV-DO”] network, an Enhanced Data Rates for GSM Evolution [“EDGE”] network, a 3GSM network, a 4GSM network, a Digital Enhanced Cordless Telecommunications [“DECT”] network , a Digital AMPS [“IS-136/TDMA”] network, or an Integrated Digital Enhanced Network [“iDEN”] network, etc.). Alternatively or in addition, the notification and any accompanying picture, video clip, and/or audio clip can be transmitted directly to the administrator-level user's remote device via such a wide-area network. These communication options are schematically illustrated in FIG. 17.

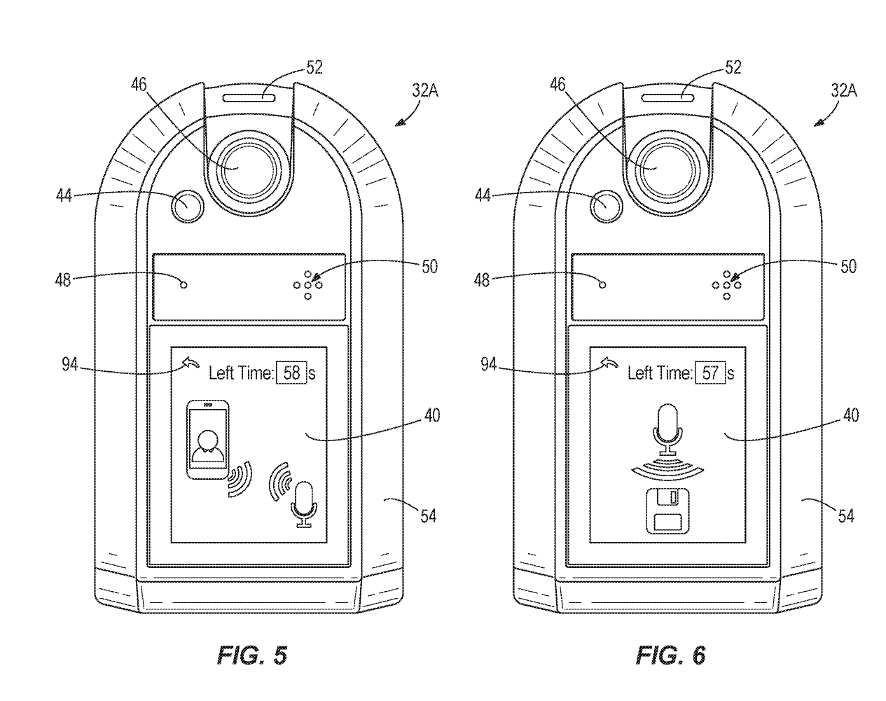

However, the door lock 32 may also enable a call function or a message function to be carried out by the visitor, the screen sequence of which is schematically illustrated in FIG. 19. To activate either of the call function or the message function, the visitor first touches the COMMUNICATE icon 88 from the home menu of the touch screen 40 (FIG. 3, with corresponding schematic representation in FIG. 19). This brings up a sub-screen (FIG. 4, and again with corresponding schematic representation in FIG. 19) whereby the user can touch either a CALL icon 90 or a MESSAGE icon 92. A BACK icon 94 allows the user to return to the main menu. Upon touching the CALL icon 90, the touch screen 40 displays the screen shown in FIG. 5, and further utilizes the wireless communication device 104 within the door lock 32 to establish real time 2-way communication (via the microphone 48 and the speaker 50) with the administrator-level user via the personal computer 108 or the remote device of the administrator-level user. This communication can be direct via a wide-area network as described above in connection with notifications to the administrator-level user, or via a combination of location-specific and wide-area networks as also described above. In some constructions, the communication can be a full function video call providing audio and video on both ends of the call. In other constructions, or as set by the administrator-level user, the call can include any combination of audio and video, either in 2-way or 1-way communication. For example, the call can provide real time audio and video of the visitor at the door lock 32 to the administrator-level user's computer 108 and/or to the administrator-level user's remote device (via the location-specific network and/or the wide-area network), but may only provide audio from the administrator-level user to the visitor at the door lock 32. When the call is requested from the visitor at the door lock 32, a request may be sent to the administrator-level user and the administrator-level user may grant approval before any real time communication is established. At the time of the approval request, the administrator-level user may also be able to select the type of communication allowed for the call (e.g., audio only, audio with 1-way video, audio with 2-way video). Any variety of real time communication between the door lock 32 and the administrator-level user as described above can also be initiated by the administrator-level user via the computer 108 and/or the user's remote device. This may permit the administrator-level user to monitor (audio and/or video) the area surrounding the dwelling at any time on-demand, and optionally to communicate with anyone in the vicinity of the door lock 32.

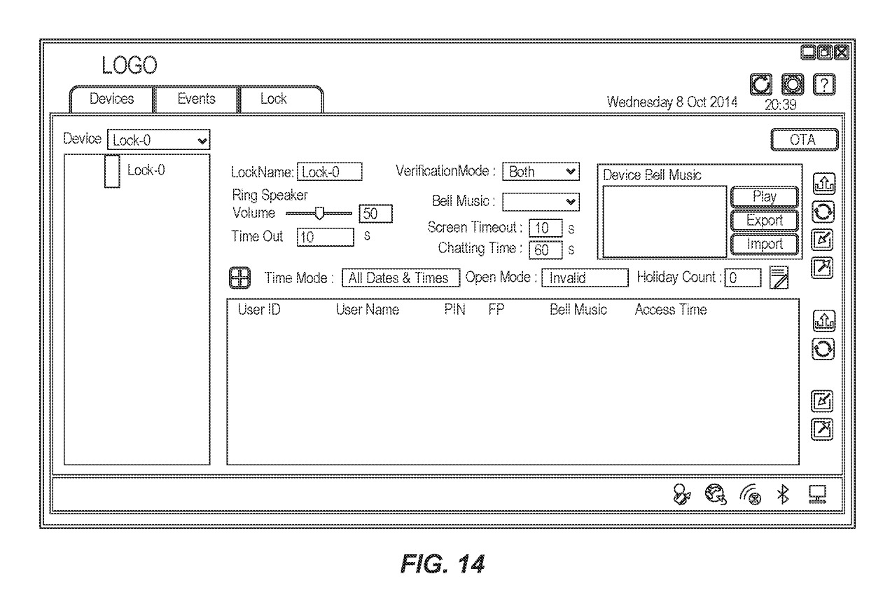

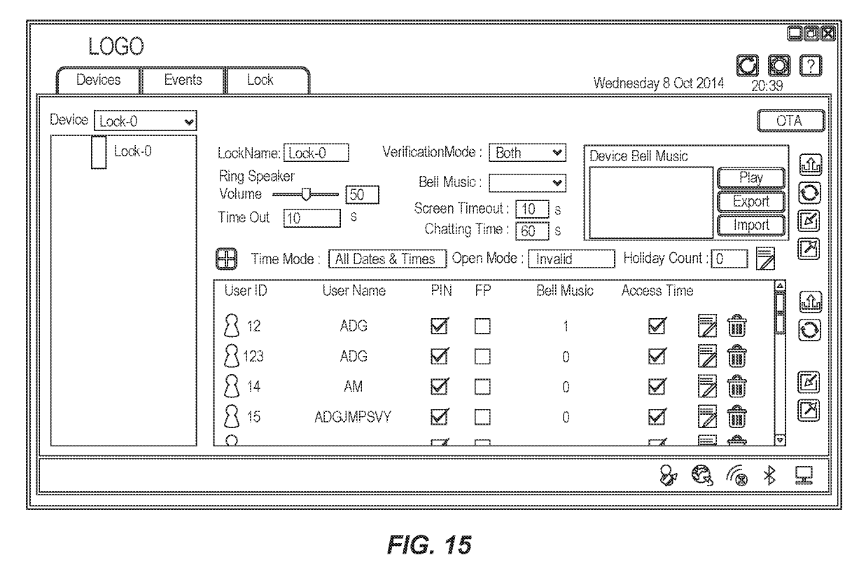

If the visitor at the door 20 is not able to establish communication with the administrator-level user, or simply elects to use the message function instead, he/she touches the MESSAGE icon 92 from the screen shown in FIG. 4. The touch screen 40 then displays the screen shown in FIG. 6 while allowing the visitor to record a voice message via the microphone 48, which can be saved locally by the controller 116 to a memory 120 of the door lock 32 and/or automatically sent as a notification to the personal computer 108 and/or the remote device of the administrator-level user for review in any of the manners described above. Such messages can be managed through the software or web portal interface (FIGS. 14 and 15) on the user's personal computer 108 or the mobile application loaded on the user's remote device (e.g., mobile phone 112A as shown in FIG. 16). Optionally, the call function and the message function can each be time limited by the controller 116 (e.g., to 60 seconds or another predetermined duration). The touch screen 40 can display the remaining time to the visitor during the call or message. It is also noted that calls and messages are not strictly limited to audio, and may include one or both of still image(s) and video clips as opposed to audio or in addition to the audio. If not automatically transmitted from the door lock 32 as described above, the content of the message may be accessed and viewed or played directly from the memory 120 of the door lock 32 when the administrator-level user is present, or the content of the message may be transmitted to the remote device and played back upon request by the administrator-level user. The content of messages may be retained by the memory 120 for a set period of time or until transmitted to another storage medium and/or deleted by the administrator-level user. The content of messages, in addition to all other information (e.g., identity, time and date) relating to users operating or visiting the door lock 32 may be stored and accessible via a “History View” screen of the interior touch screen 60, accessible through the “Settings” from the “Main Menu” as shown in FIG. 18. The same or similar information may be accessible from one or both of the personal computer 108 and the remote device.

In some constructions, the door lock 32 may record and either store or transmit content (e.g., still images, video, audio) related to individuals present at the exterior side of the door whether or not the MESSAGE icon 92 is engaged. For example, the camera 44 may serve as a motion sensor (e.g., using infrared light), and in response to detected motion, the camera 46 and/or the microphone 48 may collect content for later review by the administrator-level user. In some constructions, the controller 116 may filter the output signal of the camera 44 so that the automatic recording of content is activated only when a human face is recognized. Alternatively or in addition to automatically triggering recording of content with the camera 44, the microphone 48 may be used as the trigger (e.g., in response to the controller 116 identifying sound above a certain threshold level or recognizing human speech).

The door lock 32 can further provide real time 1-way communication in a peephole function. In such a function, the administrator-level user can monitor an output of the camera 46 and/or the microphone 48 for surveying the sights and/or sounds of the area adjacent the outside of the door 20. The peephole function may be initiated in response to a dedicated command from the administrator-level user as directed from the personal computer 108 and/or the remote device. Alternately, the peephole function can be initiated by the camera 44, which serves as a motion sensor (e.g., using infrared light). The controller 116 may filter the output signal of the camera 44 so that the peephole function is activated only when a human face is recognized. A similar peephole function may be available directly at the interior module 32B, and may not require administrator-level authority. The peephole function at the interior module 32B can be activated by the camera 44 detecting the presence of a human at the area adjacent the outside of the door 20 or at any time desired by a user on the inside of the door (e.g., by navigating through a designated menu of the touch screen 60). As mentioned above, the microphone 48 may alternatively or additionally be used as a trigger for the peephole function.

Additional settings are available to the administrator-level user at the touch screen 60, and also from the personal computer 108 and/or remote device. For example, the door lock 32 can be programmed to allow access to certain other users only within a designated time and/or on designated days. The nature in which a particular user must authenticate their identity (e.g., via keypad, biometrics, or both) can also be set, for example, through an “Open Form” setting. The “Open Form” setting may further allow reconfiguration of the door lock 32 for use on right-hand opening doors and left-hand opening doors (i.e., reversing the rotation of the motor 100 for the deadbolt 34 to function properly). The door lock 32 can also be set to lock and unlock automatically at designated times on designated days via a “Time Setting” feature. This can be particularly useful in automatically opening and securing doors of a commercial business to reliably control access by customers or staff. A “Holidays” setting can be utilized to alter or pre-empt the normal locking/unlocking schedule on designated days (e.g., when the business has alternate hours or is closed).

In addition to all the functionality provided to the user(s) located at one side or the other of the door lock 32, the wireless communication device within the door lock 32 further enables remote control of the door lock 32. For example, the locked/unlocked state can be manipulated by the administrator-level user via a personal computer 108 within the dwelling. The user can access the software or web portal interface from the personal computer 108, and a lock/unlock icon can be selected. A wireless signal is then transmitted from the personal computer 108 or a connected wireless transmitter device to the wireless communication device 104 of the door lock 32 to actuate the motor 100 that is coupled to the deadbolt 34. A similar method can be carried out by the administrator-level user via his or her remote device. For example, as shown in FIG. 16, a mobile application installed on a mobile phone 112A can include an unlock icon 150 and a lock icon 152. The remote device can communicate directly or indirectly with the personal computer 108 or other wireless communication device located within the dwelling, which in turn communicates wirelessly with the wireless communication device 104 of the door lock 32 to actuate the motor 100 that is coupled to the deadbolt 34. All such wireless communications from the administrator-user's personal computer 108, remote device, or other wireless transmitter device to the door lock 32 can be via any of the location-specific networks described above and/or via any of the wide-area networks also described above.

The personal computer 108 and/or remote device 112 can also be used to turn the camera 46 on and off and/or to turn the microphone 48 on and off at any time on command. Various settings and parameters of the door lock 32, including user ID's, PINs, personalized doorbells, etc. can also be added, modified, and deleted remotely through a software interface, web portal, or mobile application. In some constructions, the full complement of settings and operational capabilities of the door lock 32 (or any subset thereof) can be manipulated and effectively reprogrammed by the administrator-level user without being present at the door lock 32. For example, a web portal or software accessed via the personal computer 108 can allow adding and/or changing users, user settings and permissions (including PIN number or authentication mode), wireless communication modes, lock control, and so on. All of these may also be reprogrammed at any time from the administrator-level user's remote device, which is particularly useful when the administrator-level user is away from the dwelling.

Upon initial use or setup, the administrator-level user must establish administrator-level rights to his/her remote device. From that point forward, the remote device may or may not request authentication (e.g., via password, PIN, etc.) upon each opening of the door lock-controlling mobile application, or upon selected operations.

Although the door lock 32 can include a primary on-board battery and/or battery pack on a power source board to provide power to the interior and exterior interfaces and the motor 100 controlling the deadbolt 34, one or more back-ups may be provided. If the primary battery falls below a predetermined voltage threshold, a super capacitor board becomes activated. The super capacitor board provides back up power for the door lock 32 when the primary battery becomes discharged. In such instances, a super capacitor of the super capacitor board is charged with the remaining voltage power from the battery. The super capacitor is then used to provide momentary power to the door lock 32 such that even when the primary battery becomes discharged, a user can still, at least momentarily, turn on and operate the door lock 32 (e.g., to gain access to the dwelling).

The super capacitor board can include a comparison module, a buck-boost circuit, the super capacitor, a display, and the load. The comparison module is connected to the battery from the power source board to determine when the battery drops below the predetermined voltage threshold (e.g., 4.4V). The comparison module may be implemented in hardware using a differentiator circuit for example, or may be implemented in software, or a combination thereof. When the battery state of charge is below the predetermined voltage threshold, the comparison module outputs a control signal to both the buck-boost circuit and the display. The display receives the signal and provides an indication to the user that the battery is low. The display can be incorporated into one or both of the touch screens 40, 60, or may be separate.

Although the primary battery may not be able to power the door lock 32, the battery may still be able to provide electrical power. Therefore, the buck-boost circuit receives power from the primary battery and provides an approximately 6V power output to the super capacitor. The super capacitor receives the electrical energy and stores the electrical energy until the super capacitor is fully charged. Once the super capacitor is fully charged, the super capacitor provides an electrical power output to power the door lock 32. In some constructions, the super capacitor charges in about 60 seconds and provides a 7V power output. The super capacitor can provide approximately 350 mA at about 63% efficiency. Because the super capacitor contains a limited amount of energy, the super capacitor powers the door lock 32 for a limited period of time. In some constructions, the super capacitor powers the door lock 32 for approximately 12 seconds. Therefore, when the door lock 32 is powered by the super capacitor, the door lock 32 operates in an ultra-low power mode. In the ultra-low power mode, the door lock 32 authenticates a user based on a code entered on the touch screen 40 or on a reading obtained from the user via the biometric sensor 52. Additional secondary boards of a modular PCB within the door lock 32 are not powered and therefore help the door lock 32 to conserve power.

Providing the super capacitor allows the door lock 32 to receive power from a battery even after the battery has dropped below a power level needed to power the door lock 32 directly. For example, the battery provides approximately 6.5 V to the door lock 32. When the battery drops below the predetermined voltage threshold (e.g., 4.4 V), the battery can no longer provide sufficient power to the door lock 32. The super capacitor, however, can be charged with voltage below the voltage threshold and build up charge over time. When the super capacitor harvests sufficient power (e.g., 7V), the super capacitor provides the electrical energy to the door lock 32. Because the super capacitor receives voltage from an already slightly discharged battery, the more discharged the battery (i.e., the lower the state of charge of the battery), the longer it will take for the super capacitor to reach full charge. This delay in super capacitor charging may serve as an indication to the user that the battery needs to be replaced and/or recharged.

As used herein, “interior” and “exterior” are used with the understanding that the door lock 32 is used to selectively block access from the outside to the inside. However, these are relative terms used to aid in the understanding of the features of the invention, and it will be understood that the exterior and interior modules 32A, 32B may be swapped in the event that it is desirable for a particular door application to selectively block access from inside to the outside. Also, it will be appreciated that interior doors that do not clearly have an “interior” side and an “exterior” side can be provided with either of the two modules 32A, 32B described herein in any relative position.

Various features and advantages of the invention are set forth in the following claims.

1. A door lock comprising:
an exterior module mountable on an exterior surface of a door;
an interior module mountable on an interior surface of a door;
a deadbolt movable between an unlocked position allowing opening of the door from a closed state and a locked position preventing opening of the door from the closed state; and
either or both a camera and a microphone provided on the exterior module;
a wireless communication device configured to communicate either or both of images from the camera and sound from the microphone in real time to a smart phone or computer of an authorized user for remote observation of an area adjacent the exterior surface of the door.

2. The door lock of claim 1, wherein the exterior module includes a motion sensor, and the wireless communication device is enabled to begin communication upon detection of an entity in the area adjacent the exterior surface of the door by the motion sensor.

3. The door lock of claim 2, wherein the at least one of the camera or microphone is kept in an off state until an entity is detected in the area adjacent the exterior surface of the door by the motion sensor.

4. The door lock of claim 3, wherein the motion sensor is operable to distinguish between human and non-human entities by face identification, and the at least one of the camera or microphone is kept in an off state until a human entity is detected in the area adjacent the exterior surface of the door by the motion sensor

5. The door lock of claim 1, wherein the at least one of a camera or microphone includes a camera and a microphone configured to provide images and sound from the area adjacent the exterior surface of the door to the smart phone or computer of the authorized user.

6. The door lock of claim 1, wherein the at least one of a camera or microphone includes a video camera operable to provide a video feed of the area adjacent the exterior surface of the door to the smart phone or computer of the authorized user.

7. (canceled)

8. (canceled)

9. The door lock of claim 1, wherein the exterior module includes a touch screen interface.

10. The door lock of claim 1, wherein the exterior module includes an interface having a keypad operable to identify the authorized user by a pre-programmed PIN and, in response, the door lock is operable to move the deadbolt from the locked position to the unlocked position.

11. The door lock of claim 1, wherein the exterior module includes a biometric device operable to identify the authorized user by a biometric parameter of the user and, in response, the door lock is operable to move the deadbolt from the locked position to the unlocked position.

12. The door lock of claim 11, wherein the biometric device is a fingerprint scanner.

13. The door lock of claim 1, further comprising an internal battery coupled to an electric actuator operable to move the deadbolt from the locked position to the unlocked position.

14. The door lock of claim 13, further comprising a capacitor operable to harvest electrical energy from the internal battery when the internal battery is below a predetermined threshold level that is insufficient for operating the electric actuator to move the deadbolt from the locked position to the unlocked position, wherein the capacitor is configured to power the electrical actuator for at least one movement of the deadbolt from the locked position to the unlocked position.

15. The door lock of claim 13, further comprising a pair of electrical terminals provided on the exterior module and configured to provide electrical power from an external battery to power the electrical actuator to move the deadbolt from the locked position to the unlocked position when the internal battery is below a predetermined threshold level that is insufficient for operating the electric actuator to move the deadbolt from the locked position to the unlocked position.

16. (canceled)

17. The door lock of claim 1, further comprising a speaker provided on the exterior module, wherein the wireless communication device is additionally configured to provide communication from the smart phone or computer of the authorized user to the area adjacent the exterior surface of the door via the speaker.

18. A door lock comprising:
an exterior module mountable on an exterior surface of a door, the exterior module including an interface;
an interior module mountable on an interior surface of a door;
a deadbolt movable between an unlocked position allowing opening of the door from a closed state and a locked position preventing opening of the door from the closed state, wherein the deadbolt is operable to move to the unlocked position via manual input from the interior module and the deadbolt is operable to move to the unlocked position via electronic input from the interface of the exterior module; and
a controller programmable to identify a plurality of different users via the interface, wherein the controller is operable to trigger an alert personalized to a particular one of the plurality of different users, the controller further allowing an administrator-level user to determine for each of the plurality of different users whether or not the deadbolt is moved to the unlocked position in response to the identification.

19. (canceled)

20. The door lock of claim 18, further comprising a wireless communication device, wherein the door lock communicates the personalized alert via the wireless communication device to a smart phone or computer of the administrator-level user located remotely from the door lock.

21. The door lock of claim 20, wherein the door lock is operable to move the deadbolt to the unlocked position in response to a command from the administrator-level user via the smart phone or computer.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A door lock for a door, the door lock comprising:
a deadbolt movable between an unlocked position allowing opening of the door from a closed state and a locked position preventing opening of the door from the closed state;
an interior module mountable on an interior surface of a door and providing unrestricted ability to move the deadbolt from the locked position to the unlocked position;
an exterior module mountable on an exterior surface of a door, the exterior module including an interface and a microphone; and
a controller operably coupled to the interface to enable a message mode whereby the microphone captures a voice message of a visitor present at an area adjacent the exterior surface of the door.

36. The door lock of claim 36, further comprising a wireless communication device, wherein the controller directs the wireless communication device to notify an administrator-level user of the voice message via a smart phone or computer.

37. The door lock of claim 36, wherein the controller directs the wireless communication device to establish a real time one-way or two-way communication link between the door lock and the smart phone or computer in a real time communication mode.

38. (canceled)

39. (canceled)

40. (canceled)

41. (canceled)

42. (canceled)
